(19) United States
(12) Patent Application Publication
(10) Pub. No.: US 2013/0034625 A1
(43) Pub. Date: Feb. 7, 2013

(54) Chewing gum with containing ethanol flavors

(71) Applicant: David L. Ross, (US)

(72) Inventor: David L. Ross, (US)

(21) Appl. No.: 13/366,276

(22) Filed: Feb. 4, 2012

Related U.S. Application Data
(60) Provisional application No. 61/442,689, filed on Feb. 14, 2011.

(51) Int. Cl. A23G 4/20

(52) U.S. Cl. 426/5

(57) ABSTRACT

A chewing gum item which contains one or more liquids or gels containing flavors fermented or distilled with ethyl alcohol.

### DETAILED DESCRIPTION OF THE INVENTION

Chewing gum is a flavored confectionary that involves consumption through chewing often followed by disposal of the chewing gum. Chewing gum can be made from gum base, softeners, and flavoring. In another embodiment chewing gum can be made from gum base and flavoring without softeners. See generally U.S. Pat. No. 5,415,880 to Song et al and U.S. Pat. No. 5,800,848 to Yatka et al. Both of these patents are incorporated by reference herein as part of this disclosure.

Gum base can be made from chicle, natural or synthetic rubber, latex, or other chewable material.

Softeners are often used in gum to retain moisture and can be made from glycerin or vegetable oil or other natural or synthetic oils.

Flavoring in chewing gum determines the taste sensory experience of chewing gum and can be made from natural and artificial flavors in solid or liquid form.

Chewing gum is offered in multiple different forms including stick, ball, and others. In some cases chewing gum is produced with one or more cavities which increase the surface density of the chewing gum. In other cases liquids, gels, or other substances are included by the manufacturers inside the cavity or cavities. See generally U.S. Pat. No. 5,498,429 to Orlandi et al., U.S. Pat. No. 4,513,012 to Carroll et al., and U.S. Pat. No. 4,975,288 to Hager et al. Each of these three patents is incorporated by reference herein as part of this disclosure.

A cavity is an area completely surrounded by chewing gum so liquid in the cavity generally cannot escape or be mixed with other liquids until the gum is chewed or otherwise deformed.

Ethyl alcohol is also termed ethanol or alcohol and is the intoxicating agent in fermented and distilled liquors. Ethanol is a volatile, flammable, colorless liquid. It is a powerful psychoactive drug, best known as the type of alcohol found in alcoholic beverages

An alcoholic beverage is a liquid that contains ethanol for human consumption. Alcoholic beverages are consumed through the process of drinking or otherwise through absorption in the mouth. Examples of alcoholic beverages include fermented beverages, distilled beverages, liqueur beverages, and cocktail beverages.

Alcoholic beverages may be mixed with fruit juices, sodas, syrups, spices, or other carbonated and non-carbonated liquids and solids. The combined liquid is referred to as an alcoholic beverage.

Fermentation is the chemical conversion of sugars into ethanol. Some fermented beverages include wine, beer, and cider.

Wine is a fermented beverage typically made from the juice of grapes or other fruits. Wine flavor may or may not include ethanol. Some examples of varietals of wine include but are not limited to merlot, pinot noir, malbec, chardonnay, champagne.

Cider is a fermented beverage typically made from apple juice. Cider flavor may or may not include alcohol.

Beer is a general name for a fermented beverage made by fermenting a cereal or mixture of cereals flavored with hops. Beer flavor may or may not include ethanol.

Rice wine is a fermented beverage made by converting the starch in rice into sugar. Sake, of Japanese origin, is an example of rice wine. Rice wine flavor may or may not include ethanol.

Distillation is a method of separating mixtures based on differences in their volatilities in a boiling liquid mixture. Distillation of alcoholic beverages increases the alcohol content per volume of these liquids. Distilled beverages include but are not limited to vodka, whiskey, gin, brandy, rum, and tequila. Distilled beverage flavors may or may not include ethanol.

Liquor is an alcoholic beverage that is distilled without added sugar or sugar substitutes. Liquor flavors may or may not include ethanol.

A liqueur is an alcoholic beverage that has been flavored with added sugar, syrup, or sugar or syrup substitutes to enhance sweetness or flavor. Liqueur flavor may or may not include ethanol.

A cocktail beverage is a mixture of alcoholic and non-alcoholic beverages, fruits, and other natural and synthetic flavors. Some examples of cocktail beverages include bloody mary, rum and cola, gin and tonic, daiquiri, margarita, cape cod, cuba libre, screwdriver, Russian, and pina colada. A cocktail beverage flavor may or may not include ethanol.

A fortified wine is a wine with a liquor combined in the creation of the beverage. Some examples of fortified wines include port, sherry, and vermouth. Fortified wine flavor may or may not include ethanol.

A pina colada is a cocktail whose ingredients include rum, cream of coconut, and pineapple juice. Pina colada flavor may or may not include ethanol.

A martini is a cocktail whose ingredients include gin or vodka and vermouth. Martini flavor may or may not include ethanol.

A daiquiri is a cocktail whose ingredients include rum, lime juice, and sugar or sweeteners. Daiquiris are often served with ice and may include flavors such as strawberry daiquiri, mojito, or Caipirinha. Daiquiri flavor may or may not include ethanol.

A margarita is a cocktail whose ingredients include tequila, triple sec, and lime or lemon juice. Margaritas are often served with ice and combined with other fruits and fruit juice flavors. Margarita flavor may or may not include ethanol.

A bloody mary is a cocktail whose ingredients include vodka and tomato juice, but also may include other flavorings and spices. Bloody mary flavor may or may not include ethanol.

A gin and tonic is a cocktail whose ingredients include gin and tonic water. Gin and tonic flavor may or may not include ethanol.

A cape cod is a cocktail whose ingredients include vodka and cranberry juice. Cape cod flavor may or may not include ethanol.

A cuba libre is a cocktail whose ingredients include rum and cola soda, often Coca-Cola also called rum and coke or rum and cola. Cuba libre flavor may or may not include ethanol.

A screwdriver is a cocktail whose ingredients include vodka and orange juice. Screwdriver flavor may or may not include ethanol.

A Russian is a cocktail whose ingredients include vodka and coffee liqueur. A white Russian adds a form of cream to the cocktail. Russian flavor may or may not include ethanol.

There exist a wide variety of government regulations with respect to the production, transport, and consumption of alcoholic beverages.

A beer keg is a cylindrical container, usually constructed of aluminum, steel or wood used to store, transport, and serve beer. A beer keg may also be called a cask and contain one or more openings to load and unload beer while maintaining carbonated beer liquid inside the keg.

A beer mug is a form of drink ware consisting of a large, roughly cylindrical, drinking cup with a single handle. Beer mugs are usually made of silver, pewter, or glass, but can be made of other materials, for example clay or leather. Beer mugs may also be called tankards or beer steins, or steins.

A beer bottle is a cylindrical container made of glass or plastic used to store beer for consumption.

A wine case is a rectangular box for storage and transport of wine and typically contains 12 bottles of wine enclosed.

A beer bottle is a cylindrical container made of glass or plastic used to store beer for consumption by an individual.

A wine bottle is a cylindrical container made of glass or plastic used to store wine for consumption.

A wine barrel is a hollow cylindrical container, traditionally made of vertical wooden staves and bound by wooden or metal hoops used to store and transport wine.

Volume is the 3 dimensional space that a substance or shape occupies. For regular objects volume is derived through multiplying the length times the width times the height of an object. For example, a cube with 2 centimeters height by 2 centimeters length times by 2 centimeters width would have a volume of 8 cubic centimeters. For irregular objects volume can be derived through measuring the amount of liquid displaced through placing the object in liquid. The volume of a liquid can be derived through measuring the volume in a graduated cylinder or other liquid volume measuring devices.

Volume measurements of chewing gum will typically follow close to a regular shape but may also be an irregular shape. The volume of chewing gum pieces with cavities enclosing liquid, gel, ethanol, or other substances can be between 0.1 cubic centimeters and 10 cubic centimeters. Some chewing gum pieces containing liquid, gel, ethanol, a pharmaceutical, or other substances may be smaller than 0.1 cubic centimeters. Some chewing gum pieces containing liquid, gel, ethanol, a pharmaceutical, or other substances may be may be larger than 10 cubic centimeters.

A pharmaceutical is a chemical or plurality of chemical substance intended for use in the medical diagnosis, cure, treatment, or prevention of disease.

A beverage container is a plastic, metal, or paper-based form of packaging capable of holding liquids or liquid containers. Some examples of beverage containers include but are not limited to wine barrels, beer kegs, beer bottles, wine bottles,

What is claimed is:

1. A chewing gum between 0.1 cubic centimeters and 10 cubic centimeters in volume that encloses between 0.01 milliliters and 2 milliliters of alcoholic beverage in at least one cavity inside the gum.

2. The chewing gum of claim 1, in which the alcoholic beverage includes a distilled beverage.

3. The chewing gum of claim 1, in which the alcoholic beverage includes a fermented beverage.

4. The chewing gum of claim 1, in which the alcoholic beverage includes wine flavor.

5. The chewing gum of claim 1, in which the alcoholic beverage includes beer flavor.

6. The chewing gum of claim 1, in which the alcoholic beverage includes liquor flavor.

7. The chewing gum of claim 1, in which the alcoholic beverage includes liqueur flavor.

8. The chewing gum of claim 1, in which the alcoholic beverage includes rice wine flavor.

9. The chewing gum of claim 1, in which the alcoholic beverage includes fortified wine flavor.

10. The chewing gum of claim 1, in which the alcoholic beverage includes cocktail beverage flavor.

11. A chewing gum between 0.1 cubic centimeters and 10 cubic centimeters in volume with a plurality of cavities, in which at least one cavity encloses between 0.01 milliliters and 2 milliliters of a least one composition of matter and another cavity encloses between 0.01 milliliters and 2 milliliters of at least one additional composition of matter, whereby the composition of matters are mixed in the consumer's mouth through the process of chewing.

12. The chewing gum of claim 11, in which the composition of matter includes at least one alcoholic beverage and the additional composition of matter contains at least one non-alcoholic beverage.

13. The chewing gum of claim 11, in which the composition of matter includes at least one alcoholic beverage and the additional composition of matter contains at least one alcoholic beverage.

14. The chewing gum of claim 11, in which the composition of matter includes at least one non-alcoholic beverage and the additional composition of matter contains at least one non-alcoholic beverage.

15. A chewing gum between 0.1 cubic centimeters and 10 cubic centimeters in volume that is shaped like a beverage container and encloses between 0.01 milliliters and 2 milliliters of alcoholic beverage in at least one cavity inside the gum.

16. The chewing gum of claim 15, in which the chewing gum is shaped like at least one of the following: a barrel, a wine bottle, a beer mug, a beer bottle, a beer keg, and a case of wine.

17. A packaging between 5 cubic centimeters and 100 cubic centimeters in volume for at least one chewing gum piece, wherein the packaging is shaped like a beverage container, and wherein the packaging encloses a plurality of pieces of the chewing gum of claim 1.

18. The packaging of claim 17, in which the packaging is shaped like at least one of the following: a barrel, a wine bottle, a beer mug, a beer bottle a beer keg, and a case of wine.

19. A packaging between 5 cubic centimeters and 100 cubic centimeters in volume for at least one chewing gum piece, wherein the packaging is shaped like a beverage container, and wherein the packaging encloses a plurality of pieces of the chewing gum of claim 11.

20. The packaging of claim 19, in which the packaging is shaped like at least one of the following: a barrel, a wine bottle, a beer mug, a beer bottle a beer keg, and a case of wine.
